(19) United States
(12) Patent Application Publication
(10) Pub. No.: US 2025/0115781 A1
(43) Pub. Date: Apr. 10, 2025

(54) ACRYLIC IMPREGNATION SEALANTS FOR SEALING GRAPHITE RUPTURE DISKS

(71) Applicant: Godfrey & Wing, LLC, Aurora, OH (US)

(72) Inventor: Xiaoming Wu, Aurora, OH (US)

(73) Assignee: Godfrey & Wing, LLC, Aurora, OH (US)

(21) Appl. No.: 18/481,114

(22) Filed: Oct. 4, 2023

Related U.S. Application Data
(63) Continuation-in-part of application No. 18/464,831, filed on Sep. 11, 2023.
(63) Continuation-in-part of application No. 18/196,488, filed on May 12, 2023.

(51) Int. Cl. C09D 135/02; C08F 220/18; C08F 222/20; C09D 5/22; C09D 7/41; C09D 7/63; C09D 133/06

(52) U.S. Cl. CPC C09D 135/02; C08F 220/1812; C08F 222/20; C09D 5/22; C09D 7/41; C09D 7/63; C09D 133/062

(57) ABSTRACT

An acrylic sealant is configured to seal a graphite disk that comprises: (a) one or more of a di- or tri-functional acrylate monomers, a mono-functional [meth]acrylate monomer, and an oligomeric monomer including a plurality of [meth] acrylate functional groups; and (b) a radical initiator. A method for making an impregnated, cured disk includes the steps of (a) positioning a raw graphite disk into a vacuum/pressure chamber; (b) applying a vacuum in the chamber after the raw graphite disk is positioned there; (c) immersing the raw graphite disk in a liquid acrylic sealant in the chamber after the vacuum is applied; (d) removing the vacuum in the chamber and applying a pressure to sufficiently impregnate the raw graphite disk with the liquid acrylic sealant and create an impregnated graphite disk; (e) placing the impregnated graphite disk into a curing chamber; and (f) in the curing chamber, heating the impregnated graphite disk in order to cure the liquid acrylic sealant inside of the graphite disk.

### CROSS-REFERENCE TO RELATED APPLICATIONS

This application claims priority to (1) U.S. application Ser. No. 18/464,831 entitled PROPRIETARY CURE MODULE AND METHOD FOR IMPREGNATING GRAPHITE, filed Sep. 11, 2023, and (2) U.S. application Ser. No. 18/196,488 entitled SEALANT FOR VACUUM IMPREGNATED COMPONENTS, filed on May 12, 2023. The contents of each of these applications that are not inconsistent with this disclosure are incorporated herein by reference.

### BACKGROUND

Rupture disks function as safety devices to protect vessels, piping, and other pressurized systems from excessive pressure which can lead to catastrophic damage. Before the pressure reaches a structure's maximum allowable working pressure (MAWP), the rupture disk bursts to provide a relief path. There are no moving parts in rupture disks, which is an advantage in such applications. Graphite, being pure carbon, has unique chemical, physical, and mechanical properties such as good chemical resistance, high thermal and electrical conductivity, high mechanical strength, and good processing characteristics when molded or machined. In addition, graphite has mechanical strength that is relatively insensitive to temperature fluctuation. These characteristics make graphite a good material for rupture disks. When the pressure in a structure reaches the designed limit, which is usually a pressure less than the MAWP, the graphite disk shatters into fragments. Graphite rupture disks have a variety of applications in chemical, petrochemical, food, medical, and other processing systems. Although raw graphite blocks possess high porosity, which contributes to high permeability, this shortcoming can be remedied through sealant vacuum/pressure impregnation (VPI).

VPI technology is known and is used to treat porous substrates such as wood, graphite, ceramic, casted/sintered metal, and others. Through VPI sealant treatment, a material's porosity is decreased, its density is increased, and its properties, such as fluid permeability, mechanical strength, chemical resistance, and/or environmental stability, are modified and improved. A typical sealant VPI process includes following steps: (1) in an autoclave, the porous parts are subjected to a high vacuum (preferably a dry vacuum) treatment to evacuate air from the internal pores of the porous parts; (2) liquid sealant is transferred into the autoclave and the porous parts are submerged in the sealant under the vacuum, drawing the sealant in to fill the pores in the porous parts; (3) after vacuum (now a wet vacuum because the liquid sealant is present) is released, the immersed parts are subjected to high pressure to push the liquid sealant into the parts and further penetrate the pores in the parts; (4) the parts (such as graphite disks) are removed from the sealant tank and washed with water (or water with surfactant) to remove the sealant from the part's outer surface; (5) the wet sealant-impregnated part is cured in a suitable manner, such as at an elevated temperature in a water bath to solidify the sealant inside of the part.

VPI organic sealants include sealants having polyester resins, phenolic resins, and/or acrylic resins. Resins are the main composition ingredient of a sealant. The resin selected is responsible for the sealant's processing behavior as well as mechanical, chemical, structural properties. However, there are usually other minor ingredients such as a catalyst, plasticizer, surfactant, colorant, and possibly others. In normal graphite disk impregnation, phenolic resins are generally used. Phenolic resins are also called phenol formaldehyde resins because they are synthesized through the reaction of phenol with formaldehyde. Through control of the reaction conditions, such as reaction temperature and time, basicity of the reaction mix (i.e., additives used), and the ratio between phenol and formaldehyde, liquid oligomeric phenolic resins are produced. One type of phenolic resins is called resoles, which can be cured without any crosslinking additive (also called a cross-linker). Upon being subjected to an air temperature of 120° C. or higher, a resole resin will continue reacting sufficiently to form a crosslinking polymer network while a water molecule is generated as a byproduct. Low molecular weight resoles have been used as VPI sealants.

Because of the physical properties and chemical behavior of phenolic sealants, VPI utilizing them requires high vacuums and high pressures be held for a relatively long period. Most of the process steps in such a VPI process can each take hours, thus the total processing time to create a finished, sealed graphite part can take up to a day or more. Maximizing manufacturing through-put is desirable to reduce processing costs. But present manufacturing processing times are relatively slow and can require a manufacturer to maintain an over-inventory of finished, sealed parts, because the sealing process is slow and there is no ability to quickly increase production to meet unexpected, increased sales requirements. Also, the liquid phenolic resin contains unreacted phenol and formaldehyde, which are toxic volatile organic compounds (VOCs). The toxicity is also a drawback because of continually more restrictive health and environmental regulations.

Accordingly, the conventional graphite disk sealing process using phenolic sealant has the drawbacks of (1) being relatively lengthy, (2) having high energy consumption, and (3) being a chemical regulatory concern. Thus, there is a need for alternative sealants.

### DETAILED DESCRIPTION

The description herein is to identify embodiments of a sealant resin, processes utilizing them, and impregnated graphite disks, and not to limit the scope of the claims.

Sealants of this disclosure are acrylic VPI (or impregnation) sealants possessing characteristics for graphite disk impregnation. Acrylic impregnation sealants are presently used in VPI for sealing the porosity of metal die cast or sintered parts. One advantage of acrylic sealant impregnation is its relatively fast processing time, e.g., a complete cycle for sealing metal parts takes 10-45 minutes or less. Acrylic sealants consist of one or multiple acrylic and/or methacrylic monomers, as well as a free radical initiator (or “initiator”). The monomers have a low viscosity, which means the liquid sealant, which also includes the initiator, has a low viscosity. Proper selection of monomer functionalities ensures desired sealant surface properties, such as the ability to be thoroughly removed from the outer surface of a graphite disk by washing the part with water only, although water plus a surfactant may be used. Adjusting the monomer composition to have a lower viscosity and desired surface property, the acrylic sealant quickly penetrates porous graphite disks and fills the pores using vacuum and pressure as previously described, and can be easily washed off the outer surface of a graphite disk. The radicals generated from the initiator induce monomer polymerization and consequently the sealant in a graphite part's pores solidify to seal the porosity of the disk. For such a thermal-cure acrylic sealant, with a diazo radical initiator such as VAZO 64, it usually takes less than ten minutes to cure the sealant inside of a graphite disk in a 90°-95° C. water bath. The following table shows some differences between liquid acrylic and phenolic sealants.

| Chemistry | Acrylic Sealant | Phenolic Sealant |
|---|---|---|
| Viscosity at room | 6-25 | 300 |
| temperature (RT), cps | | |
| Gravity | 0.95-1.1 | 1.22 |
| Stability at RT | Good | Poor |
| Storage temp, ° C. | 25 | 10 |
| Toxicity | N | Y |
| Volatile organic | 0 | 19-27 |
| compound, % by weight | | |
| Hazardous Materials | 1, 1, 0 | 3, 1, 2 |
| Information System | | |
| (HMIS) | | |
| Curing mechanism | Addition | Polycondensation |
| | Polymerization | |
| Curing temperature, | 90-95 (in water) | 120-160 (in air) |
| ° C. | | |

Regardless of the method of making the raw (i.e., prior to sealing) graphite rupture disks, the carbon of the graphite grains bond together through a high pressure and high temperature manufacturing process. The space between the grains becomes a graphite porosity that must be sealed in order for the graphite disk to function properly. Depending on the carbon's grain size and shape, as well as the processing conditions used to form the raw graphite disk, the graphite porosity will also have different average pore sizes, pore size uniformity, and internal surface chemical and physical properties. All of these affect the sealant performance in the impregnation process. Although not required, acrylic sealants are preferred to have processability timeframes in order to impregnate rupture disks having different grades of carbon. Compared to casted and sintered metal parts, graphite disks have larger pore size dispersity and different internal surface properties.

### Monomers

The acrylic sealant monomers of this disclosure include, but are not limited to, one or more of the following: di/tri-functional acrylic monomers. Examples may include one or more of: polyethylene glycol di[meth]acrylates, triethylene glycol di[meth]acrylate, diethylene glycol di[meth]acrylate, polypropylene glycol di[meth]acrylate, tripropylene glycol di[meth]acrylate, dipropylene glycol di[meth]acrylate, butylene glycol di[meth]acrylate, butanediol di[meth]acrylate, hexanediol di[meth]acrylate, dodecanediol di[meth]acrylate, trimethylolpropane tri[meth]acrylate, trimethylolpropane tri[meth]acrylate (ethoxylated), bisphenol-A glycidyl di[meth]acrylate, bisphenol-A ethylene glycol di[meth]acrylate, and bisphenol-A di[meth]arylate.

Mono-functional [meth]acrylic monomers that may be used in a sealant according to this disclosure include but are not limited to monomers that can further incorporate functionality designed to modify the physical properties such as one or more of greater hydrophilicity, flexibility, and better adhesion of the final cured sealant. Examples may include one or more of: acrylic acid, 2-carboxyethyl [meth]acrylate, hydroxy propyl methacrylate, lauryl [meth]acrylate, stearyl [meth]acrylate, polypropylene glycol [meth]acrylates, benzyl [meth]arylate, and 3-phenoxy-2-hydroxy propyl [meth]acrylate.

Oligomeric monomers including multiple [meth]arylate functional groups are also used to enhance the sealant viscosity and reduce the level of cure-shrinkage. These monomers include polyester [meth]arylate oligomers, and soybean oil epoxy [meth]arylate oligomers.

### Initiator

The sealant formulations also include a radical initiator. Although choices are available, in this disclosure, a diazo initiator such as VAZO 64 is preferred but no way limited. Also other initiators, such as organic peroxides, are suitable. It gives the sealants a large processing window, wherein the process can have different time parameters for different applications, in which the sealant cures in a hot water bath of, for example, 90-95° C.

### Dye

A UV-dye molecule, such as 4-methyl-7-(diethylamino) coumarin, is used as impregnation tracer. If used, this helps the detection of sealant bleeding onto the surface of the part and sealant penetration depth, wherein a part after being sealed, one can cut into or through the part to evaluate the sealant penetration.

### Viscosity

Sealant viscosity is a property that directly influences sealant impregnation of a part. The lower the viscosity, the easier it is to draw/psh the sealant into a part's porosity using vacuum and pressure. It is measured using a Brookfield viscometer, which will provide a viscosity measure in centipoise (cps). The liquid sealant viscosity for a sealant according to tis disclosure is preferably 8 cps-30 cps @ 25° C. when measured on a 00 spindle at 6 RPM.

### Sealant Curing

The rate and amount of sealant curing can be varied by altering the monomer composition however, it is mainly determined by the amount of initiator mixed with the monomer. The gel time indicating how fast the liquid sealant cures into a solid is typically measured on a heat block set to 90° C. A metal wire, culture test tube, and timer are required to perform the gel test. The metal wire is placed into the culture tube so that a portion remains outside of the tube and is long enough for a person (e.g., operator) to physically hold. The culture tube is then filled with liquid sealant. The heat block is preferably heated to about 90° C.±1° C. and the tube with sealant is placed into a well of the heat block. The heat block includes heating oil that should be at a level in the well that is higher than or equal to the sealant level in the tube in order to thoroughly heat the sealant. After about 90 seconds the wire is lifted by the operator. If the entire tube lifts with the wire, the sealant has cured. If the tube does not lift the sealant has not cured and the wire is placed back into the sealant in the tube. Then the operator can check every 3 seconds (by lifting the wire) until the sealant has cured and note the time it took for the sealant to cure. The current specification target for gel time, which indicates the cure time of the sealant in a manufacturing process, of the sealant is 1.6 to 2.4 minutes, although it could be any suitable time.

### Example 1

In a 300mL glass beaker equipped with a magnetic stir bar, a monomer mixture of triethylene glycol dimethacrylate (54 g), diethylene glycol dimethacrylate (90 g), and hydroxypropyl methacrylate (48 g) was first added. Sabio 7205, which is another monomer, (54 g) was then slowly dissolved in the above monomer mixture. Radical initiator VAZO 64 (0.77 g) and UV dye Columbia Blue (0.051 g) were added into the monomer mix as it was being stirred. The final liquid sealant had a density of 0.925g/cm³ and viscosity of 27 cps at 25° C. The liquid sealant gel time measured with 1.0 g of sealant in a test tube at 90° C. in a heat block was 2:41 min:sec. The cured sealant hardness (Shore D) was 95.

### Example 2

In a 300 mL beaker equipped with a magnetic stir bar that homogenizes a monomer mixture, 130 g of diethylene glycol dimethacrylate was mixed with 70 g of bisphenol-A ethylene glycol dimethacrylate. To this monomer mixture, 0.6 g of Vazo 64 powder was added and the mixture was agitated until the initiator was dissolved. The liquid sealant density was 1.082 g/cm3 and the viscosity was 18.0 cps at 25° C. The liquid sealant gel time measured with 1.0 g of sealant in a test tube at 90 C in a heat block was 2:46 min:sec. The cured sealant hardness (Shore D) was 95.

### Example 3

In a 300 mL beaker equipped with a magnetic stir bar, a monomer mixture of 15 g of bisphenol-A epoxy diacrylate, 10 g of triethylene glycol dimethacrylate, 53 g of diethylene glycol dimethacrylate, 95 g of lauryl methacrylate, 43 g of dodecanediol dimethacrylate, and 3 g of trimethylolpropane trimethacrylate was added and thoroughly mixed through agitation. To this agitating monomer mixture, 0.59 g of Vazo 64 powder and 0.004 g of UV dye Columbia Blue was added and until the initiator and dye were dissolved. The liquid sealant density was 0.95 g/cm3 and the viscosity was 8.0 cps at 25° C. The liquid sealant gel time measured with 1.0 g of sealant in a test tube at 90° C. in a heat block was 2:40 min:sec. The cured sealant hardness (Shore D) was 85.

### Example of Using the Acrylic Sealant

Graphite disks are placed into a chamber and a vacuum of 6.5 mBar, or an amount of 0-27 mBar, is drawn inside the chamber and on the graphite disks. Then sealant is drawn into the chamber using the vacuum to draw it in although the sealant can be placed in the chamber using any suitable method. After the graphite disks are covered (immersed) in the liquid sealant the chamber is subjected to an over pressure of approximately 6.0 Bar (3.0 Bar to 8.5 Bar is a typical range). The hydraulic effect of the overpressure helps to push the liquid sealant into the porosity of the graphite disks.

When the graphite disks are sufficiently impregnated with sealant, the pressure is lowered to atmospheric level. The extra sealant on the disk outer surface can be removed by centrifugal force. In case a better surface cleanness is required, water is used to rinse residual sealant off the surfaces of the graphite disks.

The acrylic sealant is configured to cure in 10 minutes or less, or less than 45 minutes, after being impregnated in a graphite disk and the graphite disk is positioned in pressurized and heated water, preferably heated to 70°-120° C., or most preferably 90°-95° C. The pressure of the water need only be sufficient to essentially prevent steam from forming. Alternatively, any suitable heating process can be used, such as curing with steam.

The impregnation process can be varied depending on the graphite disk size and geometry. Exemplary parameters for a process to seal graphite disks using a sealant of this disclosure follow:

| | Exemplary Value |
|---|---|
| Vacuum Impregnation | for Graphite Disks |
| Vacuum Level (mBar) | 1-6.5 mBar |
| Dry Vacuum Hold (minutes) | 10-30 |
| Wet Vacuum Hold (minutes) | 20-60 |
| Pressure Level (BAR) | 5.0-6.0 |
| Pressure Hold Time (minutes) | 30-60 |
| Liquid Sealant Temperature ° C. | 18-22 |
| Overall Cycle (hours) | 2-5 |
| | Exemplary Value |
| Rinse/Wash Cycles | for Graphite Disks |
| Temperature ° C. | 20-25 |
| Cycle Time (seconds) | Sub 600 |
| | Exemplary Value |
| Cure | for Graphite Disks |
| Water Temperature ° C. | 90 |

Void fill percentage of the impregnated graphite disks should be calculated using the following formula: % void fill=(post weight-preweight)/resin density+disk volume−(preweight/graphite density).

Pre-weight is the weight of the graphite disk before impregnation. Post weight is the weight of the graphite disk after impregnation. Disk volume is measured by a water displacement method. The impregnated disk is submerged in a deionized water tank and the volume of the displaced water is measured using a graduated cylinder. Any suitable method, however, may be used.

### Typical Material Targets for a Liquid Sealant and Finished Graphite Disk According to this Disclosure

| Property | Target |
|---|---|
| Cure profile (Time/Temp) | <100 min, <100° C. |
| Glass transition temperature | Tg >120° C. (Based on maximum FC |
| (3-pt bend) | temperature) |
| Gas tightness of the | no leaks against bias pressure >20 psi [IS |
| finished graphite disk | THERE AN UPPER RANGE? FOR |
| | EXAMPLE AT 100 PSI MAY LEAKS |
| | OCCUR?] |

### Process

The VPI of graphite disks with acrylic sealant is a relatively fast process. A high vacuum is first applied to remove air trapped inside of the porosity of the graphite disk. Under vacuum, sealant is introduced to submerge the graphite disks. The sealant penetrates the graphite disks and replaces empty space and residual air in the pores. Continually submerged in the sealant, pressure further pushes the sealant into the graphite disks porosity, filling it more. The preferred process uses suitable vacuum (0-1 torr) and pressure (>75 psi) for better sealant penetration with shorter disk processing time. The acrylic sealant impregnated disks are treated in a water bath of most preferably 90°-95° C., which cures the sealant to cure and seals the graphite porosity. The heat cure usually takes 5-6 minutes. Depending on the graphite porosity and disk dimension, the impregnation process parameters, particularly the processing time, are adjusted to gain the desired sealing performance. In this disclosure, two grades of graphite are used as examples: SGL Carbon's Sigrafine HLM and Mersen's ISO 2910, although other types of graphite suitable for use as graphite disks after being sealed may be used. Based on the measurement of volume, both have porosity of 16-17 vol %. However, due to differences in graphite grain size, they have a different pore size uniformity that results in different sealing performance of a sealant according to this disclosure. Nevertheless, the cured, sealant impregnated disks significantly reduce the permeability of graphite disks. In the case of minor leakage shown by pressure test, the disk can be impregnated for a second time. Complete sealing, wherein there are no air leaks when the graphite plates subjected to a bias pressure >20 psi can be thus achieved. However the bias pressure can be determined by disks' specific application.

### Example 1

A two-inch rupture disk, fabricated of Sigrafine HLM graphite block with diameter of 4 inch and thickness of 1 inch, was placed in a vacuum chamber with a vacuum of 1 mBar. It took 15 min to evacuate the air from the pores. Then acrylic sealant was introduced to submerge the disk. The sealant immersed disk was continually kept under vacuum for an additional 30 min. Released from vacuum, the disk was then washed with water shower for 20 sec, to remove the sealant on the outer surface. The disk was then treated with hot water bath at 90° C. for 6 min allowing the sealant in the pores in graphite disk to be cured. The sealing performance was then evaluated through a pressure test.

### Example 2

A two-inch rupture disk, fabricated of Mersen's ISO 2910 graphite block with diameter of 4 inch and thickness of 1 inch, was placed in a vacuum chamber with a vacuum of 1 mBar. It took 10 min to evacuate the air from the pores. Then acrylic sealant was introduced to submerge the disk. The sealant immersed disk was continually kept under vacuum for an additional 30 min. Releasing vacuum by filling in air, the atmosphere of the impregnation chamber was then pressurized to 95 psi for 30 min, to force the sealant to further penetrate the disk. Afterwards, the disk was washed with water shower for 20 sec, to remove the sealant on the outer surface. The disk was then treated with hot water bath at 90° C. for 6 min allowing the sealant in the pores in graphite disk to be cured. The sealing performance showed no leakage on pressure test.

### Sealing Performance

The sealing performance is evaluated with a pressure test. Based on the application requirements, the graphite disk is pressurized with the designed aerostatic pressure from one side and detect or measure the leakage from the other side. The quality of impregnation can be determined through measuring the leaking fluid volume per time unit. In this disclosure, the pass standard is set to “0 leakage” at 20-40 psi indicated with soapy water. Besides the impregnation conditions, the quality of graphite substrates also influences sealing performance. In case a disk subjected to a single impregnation does not meet the sealing requirement, a second impregnation process can be run to eliminate unacceptable leakage. The depth of sealant penetration is also evaluated through destructive cross-section analysis. A UV dye formulated into acrylic sealants emits blue photoluminescence under the dark light. The light emission from dye traces the sealant on the disk cross-section, indicates the sealant penetration depth. In another way to evaluate the depth of sealing, the impregnated disks can be machined to remove graphite from subsurface in depth. Then the machined disk is evaluated with pressure test. In case of minor leakage, again the disk can be treated with sealant impregnation for a second time to completely seal.

The following are non-limiting examples of this disclosure:

Example 1: An acrylic sealant configured to seal a graphite disk, the acrylic sealant comprising:
(a) one or more of a di- or tri-functional acrylic monomer, a mono-functional [meth]acrylate monomer, and an oligomeric monomer including a plurality of [meth]acrylate functional groups; and
(b) a radical initiator.

Example 2: The acrylic sealant of example 1 that comprises a di- or tri-functional [meth]acrylate monomer.

Example 3: The acrylic sealant of example 1 or example 2 that comprises a mono-functional [meth]acrylate monomer.

Example 4: The acrylic sealant of any one of examples 1-3 that comprises a monomer containing aromaticity in the molecule.

Example 5: The acrylic sealant of any one of examples 1-4 that includes an oligomeric monomer including a plurality of [meth]acrylate functional groups.

Example 6: The acrylic sealant of any one of examples 1-5, wherein the radical initiator is a diazo initiator.

Example 7: The acrylic sealant of example 6, wherein the radical initiator is VAZO 64.

Example 8: The acrylic sealant of any one of examples 2-7, wherein the di- or tri-functional acrylic monomer is one or more of: polyethylene glycol di[meth]acrylates, triethylene glycol di[meth]acrylate, diethylene glycol di[meth]acrylate, polypropylene glycol di[meth]acrylate, tripropylene glycol di[meth]acrylate, dipropylene glycol di[meth]acrylate, butylene glycol di[meth]acrylate, butanediol di[meth]acrylate, hexanediol di[meth]acrylate, dodecanediol di[meth]acrylate, trimethylolpropane tri[meth]acrylate, trimethylolpropane tri[meth]acrylate (ethoxylated), bisphenol-A glycidyl di[meth]acrylate, bisphenol-A ethylene glycol di[meth]acrylate, and bisphenol-A di[meth]acrylate.

Example 9: The acrylic sealant of any one of examples 3-8, wherein the mono-functional acrylic monomer is one or more of: acrylic acid, 2-carboxyethyl [meth]acrylate, hydroxy propyl methacrylate, lauryl [meth]acrylate, stearyl [meth]acrylate, polypropylene glycol [meth]acrylates, benzyl methacrylate and 3-phenoxy-2-hydroxy propyl [meth]acrylate.

Example 10: The acrylic sealant of any one of examples 5-9, wherein the oligomeric monomer including a plurality of [meth]acrylate functional groups is one or more of: polyester [meth]acrylate oligomers, and soybean oil epoxy [meth]acrylate oligomers.

Example 11: The acrylic sealant of any one of examples 1-10 that is configured to cure when inside of a graphite disk immersed in water at 90° C.-95° C.

Example 12: The acrylic sealant of any one of examples 1-11 that is configured to cure in 45 minutes or less, or 10 minutes or less, when inside of a graphite disk immersed in water at 90° C.-95° C.

Example 13: The acrylic sealant of any one of examples 1-11 that is configured to cure in 3-6 minutes when inside of a graphite disk immersed in water at 90° C.-95° C.

Example 14: The acrylic sealant of any one of examples 1-13 that further comprises a UV-dye as a tracer.

Example 15: The acrylic sealant of example 14, wherein the UV dye is 4-methyl-7-(diethylamino) coumarin.

Example 16: The acrylic sealant of any one of examples 1-15 that has a viscosity before curing of 8 cps-30 cps at 25° C. as measured on a Brookfield Viscometer with a 00 spindle at 6 rpm.

Example 17: The acrylic sealant of any one of examples 1-16 that has a liquid storage temperature before curing of 25° C.

Example 18: The acrylic sealant of any one of examples 1-18 that has a monomer mixture of triethylene glycol dimethacrylate, diethylene glycol dimethacrylate, and hydroxypropyl methacrylate.

Example 19: The acrylic sealant of any one of examples 1-17 that has a monomer mixture ratio equivalent to 54 g of triethylene glycol dimethacrylate, 90 g of diethylene glycol dimethacrylate, and 48 g of hydroxypropyl methacrylate.

Example 20: The acrylic sealant of example 19, wherein the radical initiator is VAZO 64.

Example 21: The acrylic sealant of example 19, wherein the radical initiator is 0.77 g of VAZO 64.

Example 22: The acrylic sealant of example 19 that further includes UV dye Columbia Blue.

Example 23: The acrylic sealant of example 19 that further includes 0.051 g of UV dye Columbia Blue.

Example 24: The acrylic sealant of example 19 that has a viscosity of 27 cps at 25° C.

Example 25: The acrylic sealant of example 19 that has a gel time as measured in a test tube positioned in a heat block at 90° C. of 2:41 min: sec.

Example 26: The acrylic sealant of example 19, wherein when cured the acrylic sealant has a hardness of 95 Shore D.

Example 27: The acrylic sealant of any one of examples 1-18 that has a monomer mixture ratio equivalent to 130 g of diethylene glycol dimethacrylate and 70 g of bisphenol-A ethylene glycol dimethacrylate.

Example 28: The acrylic sealant of example 27, wherein the radical initiator is VAZO 64.

Example 29: The acrylic sealant of example 27, wherein the radical initiator is 0.6 g of VAZO 64.

Example 30: The acrylic sealant of example 27, wherein the liquid sealant density is 1.082 g/cm3.

Example 31: The acrylic sealant of example 27 that has a viscosity of 18.0 cps at 25° C.

Example 32: The acrylic sealant of example 27, wherein the liquid sealant gel time measured with 1.0 g of sealant in a test tube at 90 C in a heat block is 2:46 min:sec.

Example 33: The acrylic sealant of example 27, wherein the cured sealant hardness is 95 Shore D.

Example 34: The acrylic sealant of any one of examples 1-18 that has a monomer mixture ratio equivalent to 15 g of bisphenol-A epoxy diacrylate, 10 g of triethylene glycol dimethacrylate, 53 g of diethylene glycol dimethacrylate, 95 g of lauryl methacrylate, 43 g of dodecanediol dimethacrylate, and 3 g of trimethylolpropane trimethacrylate.

Example 35: The acrylic sealant of example 34, wherein the radical initiator is VAZO 64.

Example 36: The acrylic sealant of example 34, wherein the radical initiator is 0.59 g of VAZO 64.

Example 37: The acrylic sealant of example 34 that further includes UV dye Columbia Blue.

Example 38: The acrylic sealant of example 34, wherein the liquid sealant density is 0.95 g/cm3.

Example 39: The acrylic sealant of example 34, wherein the liquid acrylic sealant viscosity is 8.0 cps at 25° C.

Example 40: The acrylic sealant of example 34, wherein the liquid sealant gel time measured with 1.0 g of sealant in a test tube at 90° C. in a heat block is 2:40 min:sec.

Example 41: The acrylic sealant of example 34, wherein the cured sealant hardness is 85 Shore D.

Example 42: A graphite disk impregnated with the sealant of any one of claims 1-41.

Example 43: The graphite disk of claim 42, wherein the sealant has been cured.

Example 44: The graphite disk of claim 43, wherein there are no air leaks through the graphite disk when subjected to a bias pressure of 20-40 psi or higher depending on application requirements.

Some further, non-limiting examples of this disclosure follow:

Example 45: A method for impregnating a graphite disk with a sealant, the method comprising the steps of:
(a) positioning a raw graphite disk into a chamber;
(b) applying a vacuum of 0-27 mBar in the chamber after the raw graphite disk is positioned in the chamber;
(c) immersing the raw graphite disk in a liquid acrylic sealant in the chamber after the vacuum is applied;
(d) removing the vacuum in the chamber and pressurizing the chamber to 3.0 Bar-8.5 Bar to sufficiently impregnate the raw graphite disk with the liquid acrylic sealant and create an impregnated graphite disk; and
(e) removing the pressure from the chamber and removing the impregnated graphite disk from the chamber.

Example 46: The method of example 45, wherein the pressure applied in the chamber is approximately 6.0 Bar, or 5.8-6.2 Bar.

Example 47: The method of example 45 or example 46, wherein the vacuum applied in the chamber is approximately 6.5 mBar, or from 1.0-6.5 mBar.

Example 48: The method of any one of examples 45-47, wherein the liquid acrylic sealant comprises:
(a) one or more of a di- or tri-functional acrylic monomer, a mono-functional [meth]acrylate monomer, and an oligomeric monomer including a plurality of [meth]acrylate functional groups; and
(b) a radical initiator.

Example 49: The method of any one of examples 45-48, wherein the liquid acrylic sealant comprises any of the sealants of claims 1-41.

Example 50: The method of any one of examples 45-49, wherein the outside surface of the graphite disk is washed with wash water or wash water mixed with surfactant after the graphite disk is removed from the chamber.

Example 51: The method of any one of examples 45-50 that further includes the step of immersing the impregnated graphite disk in water having a temperature of 70° C.-120° C. in order to cure the liquid acrylic sealant.

Example 52: The method of any one of examples 45-51 that further includes the step of immersing the impregnated graphite disk in water having a temperature of 90° C.-95° C. in order to cure the liquid acrylic sealant.

Example 53: The method of example 51, wherein the graphite disk is positioned in a curing chamber that is sufficiently pressurized so that steam does not form.

Example 54: The method of example 52, wherein the graphite disk is positioned in a curing chamber that is sufficiently pressurized so steam does not form.

Example 55: The method of any one of examples 45-50, wherein the liquid acrylic sealant is cured using steam instead of liquid water.

Example 56: The method of any one of examples 45-55, wherein the vacuum in the chamber is held for 10-30 minutes before the raw graphite disk is immersed in the liquid acrylic sealant.

Example 57: The method of any one of examples 45-56, wherein the vacuum in the chamber is held for 20-30 minutes after the raw graphite disk is immersed in the liquid acrylic sealant.

Example 59: The method of any one of examples 45-57, wherein the pressure in the chamber is 5.0-6.0 Bar.

Example 60: The method of any one of examples 45-59 that takes between 2-5 hours to complete.

Example 61: The method of any one of examples 45-60, wherein the pressure in the chamber is maintained for 30-60 minutes.

Example 62: The method of example 50, wherein the wash water or wash water mixed with surfactant has a temperature of 20° C.-25° C.

Example 63: The method of any one of examples 45-62, wherein the outside surface of the impregnated graphite disk is washed for less than 600 seconds.

Example 64: The method of any one of examples 51-55, wherein the glass transition temperature (Tg) of the cured sealant is >120° C.

Example 65: The method of any one of examples 51-55, wherein the gas tightness of the cured graphite disk is no leaks when subjected to a bias pressure of 20-40 pounds per square inch (psi) or higher based on application requirements.

Example 66: The method of any one of examples 45-65, wherein the raw graphite disk is comprised of SGL Carbon's Sigrafine H2M or Mersen's ISO 2910.

Example 67: The method of any one of examples 51-55, wherein the cure time is 5-6 minutes.

Example 68: The method of any one of examples 45-67, wherein the cured graphite disk is subjected a second time to the steps of claim 45 and a second time to the steps of any of examples 51-55.

Example 69: The method of any one of examples 45-68, wherein the impregnated graphite disk is positioned in a curing chamber and is immersed in liquid water having a temperature greater than 70° C. for 3-10 minutes in order to cure the liquid acrylic sealant inside of the graphite disk.

Example 70: The method of example 69 that further includes the step of removing the cured graphite disk from the curing chamber.

The description of embodiments provided herein is merely exemplary and is intended for purposes of illustration only; the following description is not intended to limit the scope of the claims. Moreover, the recitation of multiple embodiments having stated features is not intended to exclude other embodiments having additional or fewer features or other embodiments incorporating different combinations of the stated features.

The features of the various embodiments may be stand alone or combined in any combination. Further, unless otherwise noted, various illustrated steps of a method can be performed sequentially or at the same time, and not necessarily be performed in the order illustrated. It will be recognized that changes and modifications may be made to the exemplary embodiments without departing from the scope of the present invention. These and other changes or modifications are intended to be included within the scope of the present invention, as expressed in the following claims.

What is claimed is:

1. An acrylic sealant configured to seal a graphite disk, the acrylic sealant comprising:
(a) one or more of a di- or tri-functional acrylic monomer, a mono-functional [meth]acrylate monomer, and an oligomeric monomer including a plurality of [meth]acrylate functional groups; and
(b) a radical initiator.

2. The acrylic sealant of claim 1 that comprises a di- or tri-functional [meth]acrylate monomer.

3. The acrylic sealant of claim 1 that comprises a mono-functional [meth]acrylate monomer.

4. The acrylic sealant of claim 1 that comprises a monomer containing aromaticity in the molecule.

5. The acrylic sealant of claim 1 that includes an oligomeric monomer including a plurality of [meth]acrylate functional groups.

6. The acrylic sealant of claim 1, wherein the radical initiator is a diazo initiator.

7. The acrylic sealant of claim 6, wherein the radical initiator is VAZO 64.

8. The acrylic sealant of claim 2, wherein the di- or tri-functional acrylic monomer is one or more of: polyethylene glycol di[meth]acrylates, triethylene glycol di[meth]acrylate, diethylene glycol di[meth]acrylate, polypropylene glycol di[meth]acrylate, tripropylene glycol di[meth]acrylate, dipropylene glycol di[meth]acrylate, butylene glycol di[meth]acrylate, butanediol di[meth]acrylate, hexanediol di[meth]acrylate, dodecanediol di[meth]acrylate, trimethylolpropane tri[meth]acrylate, trimethylolpropane tri[meth]acrylate (ethoxylated), bisphenol-A glycidyl di [meth]acrylate, bisphenol-A ethylene glycol di[meth]acrylate, and bisphenol-A di[meth]acrylate.

9. The acrylic sealant of claim 3, wherein the mono-functional acrylic monomer is one or more of: acrylic acid, 2-carboxyethyl [meth]acrylate, hydroxy propyl methacrylate, lauryl [meth]acrylate, stearyl [meth]acrylate, polypropylene glycol [meth]acrylates, benzyl methacrylate and 3-phenoxy-2-hydroxy propyl [meth]acrylate.

10. The acrylic sealant of claim 5, wherein the oligomeric monomer including a plurality of [meth]acrylate functional groups is one or more of: polyester [meth]acrylate oligomers, and soybean oil epoxy [meth]acrylate oligomers.

11. The acrylic sealant of claim 1 that is configured to cure when inside of a graphite disk immersed in water at 90° C.-95° C.

12. The acrylic sealant of claim 1 that is configured to cure in 45 minutes or less, or 10 minutes or less, when inside of a graphite disk immersed in water at 70° C.-120° C.

13. The acrylic sealant of claim 1 that is configured to cure in 3-6 minutes when inside of a graphite disk immersed in water at 90° C.-95° C.

14. The acrylic sealant of claim 1 that further comprises a UV-dye as a tracer.

15. The acrylic sealant of claim 14, wherein the UV dye is 4-methyl-7-(diethylamino) coumarin.

16. The acrylic sealant of claim 1 that has a viscosity before being cured of 8 cps-30 cps at 25° C. as measured on a Brookfield Viscometer with a 00 spindle at 6 rpm.

17. The acrylic sealant of claim 1 that has a monomer mixture of triethylene glycol dimethacrylate, diethylene glycol dimethacrylate, and hydroxypropyl methacrylate.

18. The acrylic sealant of claim 1 that has a monomer mixture ratio equivalent to 54 g of triethylene glycol dimethacrylate, 90 g of diethylene glycol dimethacrylate, and 38 g hydroxypropyl methacrylate.

19. The acrylic sealant of claim 18 that has a viscosity of 27 cps at 25° C.

20. The acrylic sealant of claim 18 that has a gel time as measured in a test tube positioned in a heat block at 90° C. of 2:41 min:sec.

21. The acrylic sealant of claim 1 that has a monomer mixture ratio equivalent to 130 g of diethylene glycol dimethacrylate and 70 g of bisphenol-A ethylene glycol dimethacrylate.

22. The acrylic sealant of claim 21, wherein the liquid sealant density is 1.082 g/cm3 at 25° C.

23. The acrylic sealant of claim 21, wherein the liquid sealant viscosity is 18.0 cps at 25° C.

24. The acrylic sealant of claim 1 that has a monomer mixture ratio equivalent to 15 g of bisphenol-A epoxy diacrylate, 10 g of triethylene glycol dimethacrylate, 53 g of diethylene glycol dimethacrylate, 95 g of lauryl methacrylate, 43 g of dodecanediol dimethacrylate, and 3 g of trimethylolpropane trimethacrylate.

25. The acrylic sealant of claim 24, wherein the liquid sealant density is 0.95 g/cm3.

26. The acrylic sealant of claim 24, wherein the liquid sealant viscosity is 8.0 cps at 25° C.
